(19) United States
(12) Patent Application Publication
(10) Pub. No.: US 2026/0338575 A1
(43) Pub. Date: Oct. 29, 2026

(54) TRAVEL PATH GENERATION METHOD AND TRAVEL PATH GENERATION DEVICE

(71) Applicant: Nissan Motor Co., Ltd., Yokohama-shi, Kanagawa (JP)

(72) Inventors: Yuka YOSHIMATSU, Kanagawa (JP); Masafumi TSUJI, Kanagawa (JP)

(21) Appl. No.: 19/113,023

(22) PCT Filed: Oct. 4, 2022
(86) PCT No.: PCT/JP2022/037166

§ 371 Date: Mar. 19, 2025

(51) Int. Cl. G01C 21/36

(52) U.S. Cl. CPC G01C 21/3658

(57) ABSTRACT

A controller is configured to generate a target travel route of a subject vehicle. The controller determines whether the subject vehicle is on a priority side allowing the subject vehicle to preferentially travel over move of a pedestrian crossing a crosswalk or on a non-priority side prioritizing the move of the pedestrian over traveling of the subject vehicle in a situation where the subject vehicle passes through a target intersection and enters a connecting traffic lane included in a connecting road connected to the destination or the via-point. The controller generates the target travel route with which the subject vehicle passes through the target intersection on a priority side and enters the connecting traffic lane when the subject vehicle is on the non-priority side.

### CROSS-REFERENCE TO RELATED APPLICATIONS

This application is a U.S. national stage application of International Application No. PCT/JP2022/037166, filed on Oct. 4, 2022.

### BACKGROUND

### Technical Field

The present invention relates to a travel path generation method and a travel path generation device.

### Background Information

There has been known a technique which extracts experience information from a database in which experience information reflecting execution results of a plurality of functions during autonomous driving of a vehicle is recorded, and calculates a control route including a road with a high function achievement value indicating an achievement degree of each of the plurality of functions based on the experience information.

### SUMMARY

However, there is an intersection that needs to be passed in order to enter a connecting road connected to a destination or a via-point in a travel route to the destination or the via-point of a subject vehicle, and therefore, Japanese U.S. Pat. No. 6,914,229 B (hereinafter referred to as Patent Document 1) has the following problems. That is, when a travel route with which the subject vehicle turns right or left at the intersection and enters the connecting road is calculated, and there is generated a travel route with which the subject vehicle passes through the intersection on a non-priority side with respect to another moving body, Patent Document 1 has a problem that the subject vehicle fails to smoothly travel through the intersection when the subject vehicle travels on the travel route in an autonomously driven manner.

A problem to be solved by the present invention is to provide a travel route generation method and a travel route generation device which enable a subject vehicle to smoothly travel at an intersection which needs to be passed in order to enter a road connected to a destination or a via-point of the subject vehicle.

The present invention solves the above problem through determining whether the subject vehicle is on a priority side allowing the subject vehicle to preferentially travel over move of a pedestrian crossing a crosswalk or on a non-priority side prioritizing the move of the pedestrian over traveling of the subject vehicle in a situation where the subject vehicle passes through a target intersection and enters a connecting traffic lane included in a connecting road connected to the destination or the via-point, and generating a target travel route with which the subject vehicle passes through the target intersection on the priority side and enters the connecting traffic lane when the subject vehicle is on the non-priority side, in which the target intersection is an intersection connected to the destination or the via-point via the connecting traffic lane and located at a near side in a traveling direction in the connecting traffic lane.

The present invention enables a subject vehicle to smoothly travel at an intersection that needs to be passed in order to enter a road connected to a destination or a via-point of the subject vehicle.

### BRIEF DESCRIPTION OF DRAWINGS

Referring now to the attached drawings which form a part of this original disclosure, illustrative embodiments are shown.

FIG. 1 is a block diagram illustrating one embodiment of a travel route generation device according to an embodiment.

FIG. 2 is a drawing illustrating an exemplary situation in which a travel route is generated by a travel route generation method according to the embodiment.

FIG. 3 is a drawing illustrating an exemplary situation in which a travel route is generated by the travel route generation method according to the embodiment.

FIG. 4 is a drawing illustrating an exemplary situation in which a travel route is generated by the travel route generation method according to the embodiment.

FIG. 5 is a drawing illustrating an exemplary situation in which a travel route is generated by the travel route generation method according to the embodiment.

FIG. 6 is a flowchart diagram illustrating an exemplary control procedure of the travel route generation method according to the embodiment.

FIG. 7 is a flowchart diagram illustrating an exemplary control procedure of the travel route generation method according to the embodiment.

FIG. 8 is a flowchart diagram illustrating an exemplary control procedure of the travel route generation method according to the embodiment.

### DETAILED DESCRIPTION OF EMBODIMENTS

One embodiment of a travel route generation device according to the present invention will be described based on the drawings. Note that the following description is made on the premise that vehicles drive on the left side in a country with the law of left-side traffic. In a country with the law of right-side traffic, the following description is read by interchanging right and left since vehicles drive on the right side.

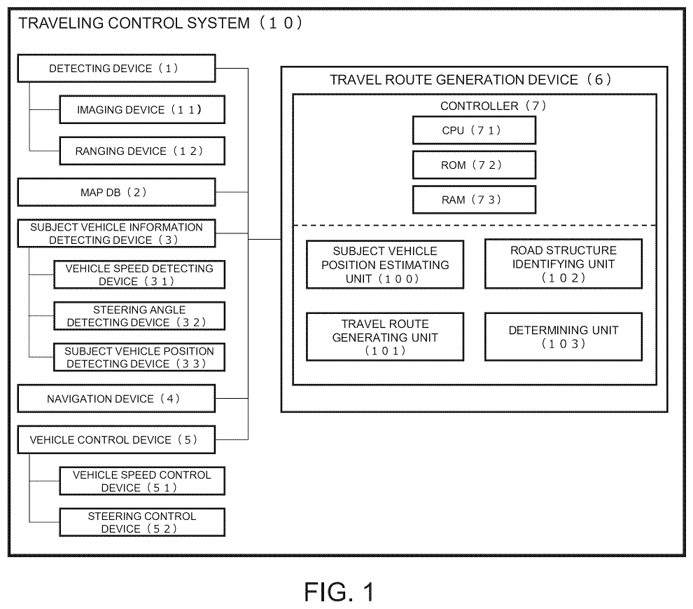

FIG. 1 is a block diagram illustrating one embodiment of a travel route generation device according to the embodiment. In FIG. 1, the travel route generation device is applied to a traveling control system. A traveling control system 10 is a system that controls traveling of a vehicle by an autonomous driving control. As illustrated in FIG. 1, the traveling control system 10 includes a detecting device 1, a map DB 2, a subject vehicle information detecting device 3, a navigation device 4, a vehicle control device 5, and a travel route generation device 6. The detecting device 1 includes an imaging device 11 and a ranging device 12. The subject vehicle information detecting device 3 includes a vehicle speed detecting device 31, a steering angle detecting device 32, and a subject vehicle position detecting device 33. The vehicle control device 5 includes a vehicle speed control device 51 and a steering control device 52. The devices included in the traveling control system 10 are connected via any in-vehicle LAN including a CAN, and are able to transmit and receive information to and from one another.

The detecting device 1 is a sensor to detect objects around the subject vehicle. The objects are, for example, automobiles other than the subject vehicle (other vehicles), motorcycles, bicycles, pedestrians, traffic lane lines on roads, zebra zones as buffer zones, centerlines, road markings, center dividers, guardrails, curbs, sidewalls on highways, traffic signs, traffic lights, crosswalks, construction sites, accident sites, and traffic restrictions. The detecting device 1 obtains positions, postures (directions), and speeds of moving bodies.

The detecting device 1 detects the objects by, for example, the imaging device 11 and/or the ranging device 12. The travel route generation device 6 obtains a detection result of the detecting device 1 at a predetermined cycle. The imaging device 11 is a device that recognizes the objects around the subject vehicle by an image, and is a camera or the like. A plurality of the imaging devices 11 may be provided in one vehicle. The ranging device 12 is a device to operate a relative distance and a relative velocity between the vehicle and the object, and is, for example, a laser radar. A plurality of the ranging devices 12 may be provided in one vehicle.

The map DB 2 stores high accuracy map information including position information of various facilities and specific locations, and is a memory (a storage medium) accessible from the travel route generation device 6. The high accuracy map information stored in the map DB 2 is three-dimensional map data based on road shapes detected when actual roads were traveled on using a data obtaining vehicle. The high accuracy map information is used in the autonomous driving control, and is map information including information more detailed than map information for navigation. The high accuracy map information is map information to which road information, boundary information of traffic lanes, road attribute information, in-bound and out-bound information of traffic lanes, traffic lane identification information, connection destination lane information, facility information, and their attribute information are associated as three-dimensional information. The road information includes information of road widths, curvature radii, road shoulder constructions, the road traffic act (speed limits, whether traffic lane change is allowed or not), road merging points, diverging points, positions where the number of traffic lanes increases or decreases, and the like. Note that the map DB 2 may be included in the travel route generation device 6.

In the embodiment, the road information is described by links sectioned by nodes, which are set for each traffic lane. The node is a reference point on a traffic lane reference line (for example, a center line in the traffic lane). Node information includes an identification number of the node, a positional coordinate, the number of traffic lane links to be connected, and identification numbers of the traffic lane links to be connected. The high accuracy map includes information of the nodes and the links per traffic lane, and therefore, the traffic lane in which the subject vehicle travels is identifiable on the travel route. The high accuracy map has coordinates that can represent positions in extending directions and traffic lane width directions of traffic lanes.

In the embodiment, the map DB 2 includes information of traffic lights installed on roads as the road information. For example, the information of traffic lights includes information of types of traffic lights at intersections and display periods of the respective signals. The types of traffic lights are, for example, a traffic light which displays arrow signals and a pedestrian-vehicle separated traffic light. These traffic lights are traffic lights that display from which connecting traffic lane a vehicle entering an intersection can enter a connecting traffic lane by preferentially passing through the intersection. For example, the arrow signal is a signal that promotes an advance only in a direction indicated by the arrow. The pedestrian-vehicle separated traffic light is a traffic light which displays which one of pedestrians and vehicles is allowed to preferentially pass through the intersection.

The subject vehicle information detecting device 3 is a device that detects information relating to a state of the subject vehicle. The state of the subject vehicle includes a traveling speed, an acceleration rate, a steering angle, a location, a posture, and the like of the subject vehicle. The vehicle speed detecting device 31 detects the traveling speed and the acceleration rate. The steering angle detecting device 32 detects the steering angle. A current location is calculated based on information obtained from the subject vehicle position detecting device 33. The subject vehicle position detecting device 33 is, for example, a positioning system including a GPS unit and the like. The posture is detected using an inertial measurement unit. The subject vehicle information detecting device 3 may obtain the traveling speed and the steering angle of the subject vehicle from the vehicle control device 5. The travel route generation device 6 obtains detection results of these devices via the in-vehicle LAN as necessary.

The navigation device 4 is a device that presents a travel route to a driver by displaying the travel route to the destination and/or the via-point set by the driver from the current location of the subject vehicle on a display. In the embodiment, the navigation device 4 obtains the travel route generated by the travel route generation device 6 and presents it to the driver.

The vehicle control device 5 is an on-board computer, such as an electronic control unit (ECU), and electronically controls on-board equipment that manages traveling of a vehicle. The vehicle control device 5 includes the vehicle speed control device 51 that controls the traveling speed of the subject vehicle and the steering control device 52 that controls a steering operation of the subject vehicle. The vehicle control device 5 obtains the travel route from the travel route generation device 6 and controls the traveling of the subject vehicle along the travel route. The vehicle control device 5 generates a control signal to control the traveling of the subject vehicle along the travel route and outputs the control signal to the vehicle speed control device 51 and/or the steering control device 52.

The vehicle speed control device 51 controls a driving device, such as an electric motor and/or an internal combustion engine as a traveling driving source and an automatic transmission. The vehicle speed control device 51 autonomously controls the traveling speed of the vehicle based on the control signal input from the vehicle control device 5. The steering control device 52 controls a steering gear. The steering control device 52 controls a behavior of the steering gear such that the subject vehicle travels by maintaining a predetermined lateral position (a position in a right-left direction of the vehicle) with respect to the travel route using at least one of a detection result of the detecting device 1, the map DB 2, and the subject vehicle information obtained by the subject vehicle information detecting device 3 based on the control signal input from the vehicle control device 5.

The travel route generation device 6 generates a target travel route to the destination set by the driver from the current location of the subject vehicle detected by the subject vehicle position detecting device 33 of the subject vehicle information detecting device 3. When the destination and/or the via-point are set by the driver, the travel route generation device 6 obtains the current location of the subject vehicle, and with reference to the map DB 2, generates the target travel route to the destination from the current location of the subject vehicle. The target travel route is in a linear shape identifying the road, the direction (in-bound/out-bound), and the traffic lane where the subject vehicle travels. The target travel route includes information on the driving lane in which the subject vehicle travels. In the embodiment, the travel route generation device 6 generates the target travel route by a controller 7. While the following description describes with an example in which a travel route to the destination is generated when the destination is set by the driver, the travel route generation method according to the embodiment may be applied not only to the destination but also to the via-point. Note that, when the destination set on the map is, for example, not on the road (but a building or a site), the controller 7 generates a target travel route with which the vehicle can enter the destination without crossing an oncoming lane from the connecting traffic lane as a road adjacent to the destination. When the destination is on a road, the controller 7 generates a target travel route corresponding to a traveling direction (in-bound/out-bound) determined for the traffic lane in which the destination is set. The via-point is, for example, any location set in the course of the target travel route to the destination. The controller 7 generates a target travel route corresponding to the traveling direction (in-bound/out-bound) determined for the traffic lane in which the via-point is set.

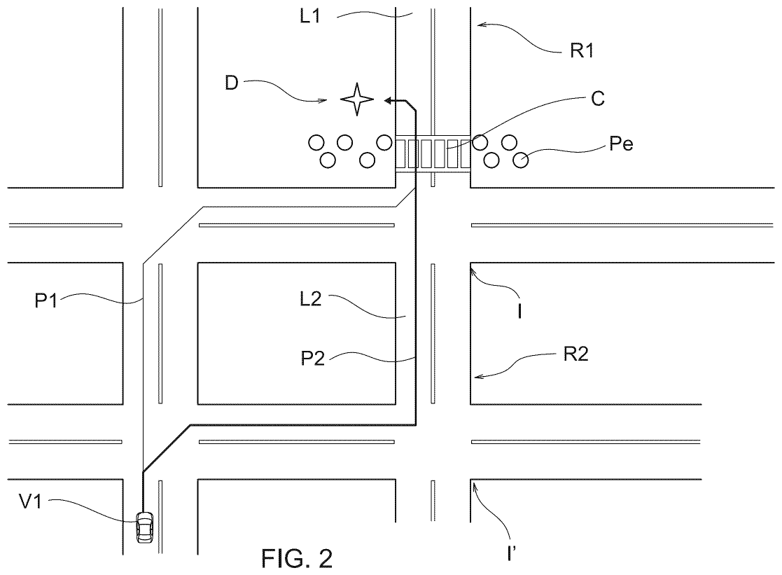

Here, with reference to FIG. 2, an exemplary situation where a travel route is generated by the travel route generation method according to the embodiment will be described. FIG. 2 is a drawing illustrating an exemplary situation where the travel route is generated by the travel route generation method according to the embodiment. In the embodiment, the controller 7 generates a first travel route P1 from the current location of a subject vehicle V1 to a destination D as a target travel route. The controller 7 identifies an intersection connected to a connecting traffic lane L1 of a destination side included in a connecting road R1 connected to the destination D at a near side in the traveling direction as a target intersection I on the first travel route P1. The target intersection I is an intersection connected to the destination D via the connecting traffic lane L1 and located at a near side in the traveling direction of the connecting traffic lane L1. The connecting road R1 is a road on which the subject vehicle V1 travels just before reaching the destination D.

When the subject vehicle V1 passes through the target intersection I on a non-priority side and enters the connecting traffic lane L1 of the destination side when the subject vehicle V1 travels on the first travel route P1, the controller 7 generates a second travel route with which the subject vehicle V1 passes through the target intersection I on a priority side and enters the connecting traffic lane L1 of the destination side as a target travel route, and updates the target travel route from the first travel route to the second travel route. The priority side is a situation in which the subject vehicle is allowed to preferentially travel with respect to a move of another moving body. When the subject vehicle travels through the target intersection in a straight line and enters the connecting traffic lane of the destination side, the subject vehicle is allowed to preferentially travel with respect to a pedestrian crossing a crosswalk at the target intersection and the other vehicle turning right or left at the target intersection and entering the connecting traffic lane of the destination side.

The non-priority side is a situation where the subject vehicle needs to prioritize the move of the other moving body over the traveling of the subject vehicle. For example, when the subject vehicle turns left at the target intersection and enters the connecting traffic lane of the destination side, the subject vehicle needs to prioritize crossing of a pedestrian walking on the crosswalk located in the course of turning left. When the subject vehicle turns right at the target intersection and enters the connecting traffic lane of the destination side, the subject vehicle needs to prioritize passing of an oncoming vehicle traveling in an oncoming lane through the target intersection. When the subject vehicle turns right or left at the target intersection after pausing and enters the connecting traffic lane, the subject vehicle needs to prioritize the move of the other moving body over the traveling of the subject vehicle. Thus, when the subject vehicle cannot smoothly pass through the target intersection on the non-priority side, the embodiment generates a travel route with which the subject vehicle is allowed to pass through the target intersection on the priority side, and controls such that the subject vehicle can smoothly travel through the target intersection.

As illustrated in FIG. 2, with the first travel route P1, in order to turn left at the target intersection I and enter the connecting traffic lane L1 of the destination side, the subject vehicle V1 needs to prioritize walking of a pedestrian Pe walking on a crosswalk C for crossing the connecting road R1, and the subject vehicle V1 passes through the target intersection I on the non-priority side. In such a case, the embodiment generates the second travel route P2. With the second travel route P2, the subject vehicle V1 travels through the target intersection I in a straight line and enters the connecting traffic lane L1 of the destination side. When a traffic light on the road on which the subject vehicle V1 travels displays a signal indicating a permission of passing, a traffic light at the crosswalk C displays a signal indicating a prohibition of passing, and therefore, the subject vehicle V1 can preferentially travel through the target intersection I over the pedestrian Pe. That is, the subject vehicle V1 passes through the target intersection I on the priority side, thereby achieving smooth traveling through the target intersection.

In the embodiment, while the advantageous effect is provided particularly in the situation as illustrated in FIG. 2, the embodiment is not limited to this, and also in the case where a first travel route with which the subject vehicle V1 turns right at the target intersection I and enters the connecting traffic lane L1 of the destination side is generated, the target travel route is updated from the first travel route to a second travel route with which the subject vehicle V1 passes through the target intersection I on the priority side and enters the connecting traffic lane L1 of the destination side. This enables the subject vehicle to smoothly travel through the target intersection.

The controller 7 is a computer including a ROM 72 in which programs are stored, a CPU 71 as an operation circuit to function as the travel route generation device 6 by executing the programs stored in the ROM 72, and a RAM 73 that functions as an accessible storage device. The controller 7 according to the embodiment executes respective functions by collaboration of software for achieving the above-described functions and the above-described hardware.

The controller 7 includes a subject vehicle position estimating unit 100, a travel route generating unit 101, a road structure identifying unit 102, and a determining unit 103 as function blocks. Note that while the embodiment describes functions of the respective function blocks by dividing the functions of the controller 7 into four blocks, the functions of the controller 7 are not necessarily divided into four blocks as long as the configuration allows achievement of the respective functions.

The subject vehicle position estimating unit 100 estimates the location and the posture of the subject vehicle on the map. The subject vehicle position estimating unit 100 estimates the current location and the posture of the subject vehicle on the map based on the map information obtained from the map DB 2 and the location and the posture obtained from the subject vehicle information detecting device 3.

The travel route generating unit 101 generates a target travel route of the subject vehicle from the current location of the subject vehicle to the destination. The travel route generating unit 101 identifies the location of the destination on the map obtained from the map DB 2 when the driver of the subject vehicle inputs the destination. The travel route generating unit 101 then generates the target travel route based on the current location of the subject vehicle estimated by the subject vehicle position estimating unit 100 and the identified location of the destination.

For example, the travel route generating unit 101 obtains a plurality of travel routes from the current location of the subject vehicle to the destination, and calculates costs of the travel routes for the plurality of travel routes. The travel route generating unit 101 then generates the travel route with the smallest cost among the plurality of obtained travel routes as the target travel route. For example, the cost is a required time.

When the subject vehicle passes through the target intersection on the non-priority side and enters the connecting traffic lane, the travel route generating unit 101 generates a target travel route with which the subject vehicle passes through the target intersection on the priority side and enters the connecting traffic lane.

For example, the travel route generating unit 101 firstly generates a first travel route from the current location of the subject vehicle to the destination as the target travel route. The travel route generating unit 101 then determines whether the subject vehicle passes through the target intersection on the non-priority side and enters the connecting traffic lane on the first travel route or not. When the subject vehicle passes through the target intersection on the non-priority side and enters the connecting traffic lane on the first travel route, the travel route generating unit 101 changes the target travel route from the first travel route to the second travel route with which the subject vehicle passes through the target intersection on the priority side and enters the connecting traffic lane. While the embodiment describes that the target travel route is updated from the first travel route to the second travel route when the subject vehicle passes through the target intersection on the non-priority side and enters the connecting traffic lane on the first travel route, the embodiment is not limited to this, and the target travel route with which the subject vehicle passes through the target intersection connected to the connecting traffic lane at a near side in the traveling direction on the priority side and enters the connecting traffic lane may be directly generated when the travel route is generated.

Here, an exemplary generation method of a travel route according to the embodiment will be described. When the subject vehicle passes through the target intersection on the non-priority side and enters the connecting traffic lane, the travel route generating unit 101 obtains a non-priority travel route with which the subject vehicle passes through the target intersection on the non-priority side and enters the connecting traffic lane and a priority travel route with which the subject vehicle passes through the target intersection on the priority side and enters the connecting traffic lane among the travel routes from the current location of the subject vehicle to the destination. For example, the non-priority travel route is a travel route with which the subject vehicle turns right or left at the target intersection and enters the connecting traffic lane. The priority travel route at least includes the connecting traffic lane, the target intersection, and the traffic lane in which the subject vehicle should travel before entering the target intersection in order for the vehicle to pass through the target intersection on the priority side among entry lanes for entering the target intersection. For example, the priority travel route is a travel route with which the subject vehicle travels through the target intersection in a straight line and enters the connecting traffic lane. The travel route generating unit 101 then calculates the cost of the non-priority travel route to be larger than the cost of the priority travel route. The travel route generating unit 101 compares the cost of the non-priority travel route with the cost of the priority travel route, and generates the target travel route including the priority travel route with a smaller cost.

In the embodiment, the priority travel route may include a priority left-turn route with which the subject vehicle turns left at the target intersection on the priority side and enters the connecting traffic lane, a priority straight route with which the subject vehicle travels through the target intersection in a straight line on the priority side and enters the connecting traffic lane, and a priority right-turn route with which the subject vehicle turns right at the target intersection on the priority side and enters the connecting traffic lane. Even with the travel route with which the subject vehicle turns right or left at the target intersection and enters the connecting traffic lane, when a traffic light installed at the target intersection displays the signal prioritizing the right or left turn, the subject vehicle is allowed to turn right or left at the target intersection on the priority side, and therefore, such a travel route serves as one of the priority travel routes.

The priority left-turn route is, for example, a route with which the subject vehicle turns left at the target intersection and enters the connecting traffic lane when a traffic light which displays a signal indicating left-turn priority is installed at the target intersection. The left-turn priority means that the vehicle can turn left at the target intersection on the priority side and enter the connecting traffic lane. Such a traffic light is, for example, a traffic light displaying an arrow signal of left turn or a pedestrian-vehicle separated traffic light.

The priority right-turn route is, for example, a route with which the subject vehicle turns right at the target intersection and enters the connecting traffic lane when a traffic light which displays a signal indicating right-turn priority is installed at the target intersection. The right-turn priority means that the vehicle can turn right at the target intersection on the priority side and enter the connecting traffic lane. Such a traffic light is, for example, a traffic light displaying an arrow signal of right turn or a pedestrian-vehicle separated traffic light.

The travel route generating unit 101 obtains the priority left-turn route, the priority straight route, and the priority right-turn route as the priority travel routes. For example, the travel route generating unit 101 identifies a type of the traffic light installed at the target intersection based on the map information obtained from the map DB 2, and identifies the priority left-turn route, the priority straight route, and the priority right-turn route among the plurality of travel routes with which the vehicle passes through the target intersection and enters the connecting traffic lane. The travel route generating unit 101 then calculates the cost of the priority right-turn route to be larger than the cost of the priority left-turn route and the cost of the priority straight route. The travel route generating unit 101 compares the cost of the priority left-turn route, the cost of the priority straight route, and the cost of the priority right-turn route, and generates a target travel route including the priority left-turn route or the priority straight route with smaller costs.

After traffic lane identification controls are executed for a predetermined number of times by the road structure identifying unit 102 described below, the travel route generating unit 101 generates a target travel route such that the subject vehicle travels in a priority entry lane identified by the traffic lane identification controls.

The travel route generating unit 101 generates a target travel route with which the subject vehicle passes through the target intersection on the priority side and enters the connecting traffic lane when there is a possibility that smooth traveling is not achieved when the subject vehicle travels through the target intersection on the non-priority side. When there is a possibility that smooth traveling is not achieved when the subject vehicle travels through the target intersection on the non-priority side is, for example, when the crosswalk of the connecting road side at the target intersection is crowded with pedestrians, when a vehicle speed difference between the subject vehicle turning left at the target intersection and entering the connecting traffic lane and an oncoming vehicle turning right at the target intersection and entering the connecting traffic lane is large, when the subject vehicle enters a traffic lane other than the traffic lane closest to the subject vehicle after passing through the target intersection, when the destination or the via-point is located within a predetermined distance from the target intersection, and when there is an obstacle or there is a possibility of an obstacle which interferes the traveling of the subject vehicle in a section between the destination or the via-point and the target intersection in the connecting traffic lane. In the embodiment, the travel route generating unit 101 generates a target travel route with which the subject vehicle passes through the target intersection on the priority side and enters the connecting traffic lane when the determining unit 103 described below determines that there is a possibility that the subject vehicle fails to smoothly travel if the subject vehicle travels through the target intersection on the non-priority side.

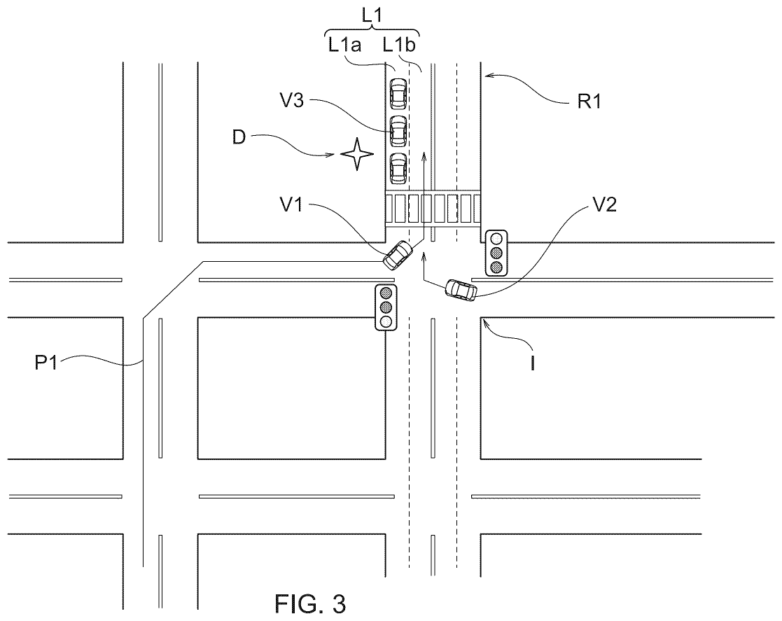

Here, with reference to FIG. 3, the situation where the subject vehicle enters a traffic lane other than the traffic lane closest to the subject vehicle after passing through the target intersection will be described. FIG. 3 is a drawing illustrating an exemplary situation where the subject vehicle enters a traffic lane other than the traffic lane closest to the subject vehicle after passing through the target intersection. In FIG. 3, the connecting traffic lane L1 is constituted of two traffic lanes including a connecting traffic lane L1a of the destination side and an adjacent lane L1b adjacent to the connecting traffic lane L1a. Generally, the subject vehicle V1 turning left at the target intersection I and entering the connecting traffic lane L1 travels in the traffic lane L1a closest to the subject vehicle V1 after passing through the target intersection I, but, for example, when there is an obstacle, such as a parked vehicle V3, in the traffic lane L1a as illustrated in FIG. 3, the subject vehicle V1 travels in the adjacent lane L1b as a traffic lane other than the traffic lane L1a after passing through the target intersection I. The obstacle is not limited to a parked vehicle, but may be a construction site and the like. Meanwhile, an oncoming vehicle V2 turning right at the target intersection I and entering the connecting traffic lane L1, in a usual case, determines that the subject vehicle V1 would travel in the connecting traffic lane L1a and attempts to travel in the adjacent lane L1b with a speed increase. Thus, the subject vehicle V1 and the oncoming vehicle V2 are more likely to come close to one another.

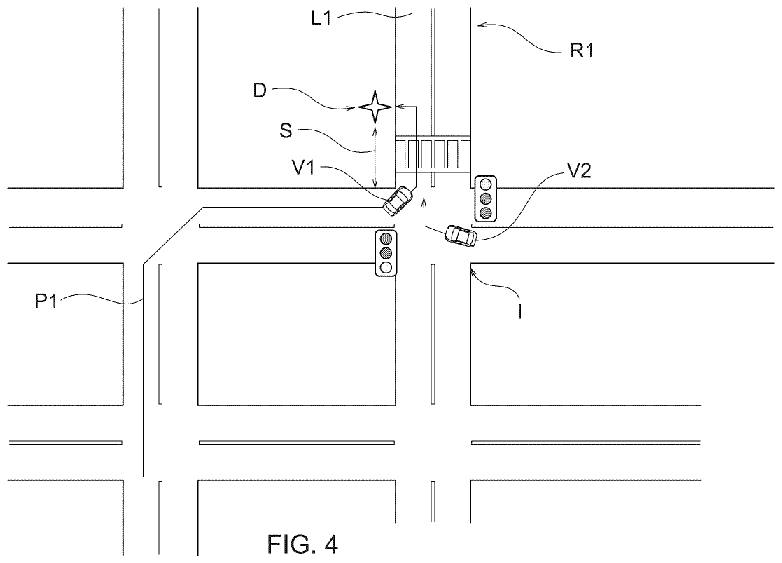

Next, with reference to FIG. 4, a situation where the destination is located within a predetermined distance from the target intersection will be described. FIG. 4 is a drawing illustrating an exemplary situation where the destination is located within the predetermined distance from the target intersection. As illustrated in FIG. 4, when a distance S of a section between the destination D and the target intersection I is short, that is, the destination D is close to the target intersection I, the subject vehicle does not accelerate since the subject vehicle V1 immediately stops after passing through the target intersection I. Meanwhile, the oncoming vehicle V2 turning right at the target intersection I and entering the connecting traffic lane L1 travels with a speed increase after passing through the target intersection I, and therefore, the subject vehicle V1 and the oncoming vehicle V2 are more likely to come close to one another.

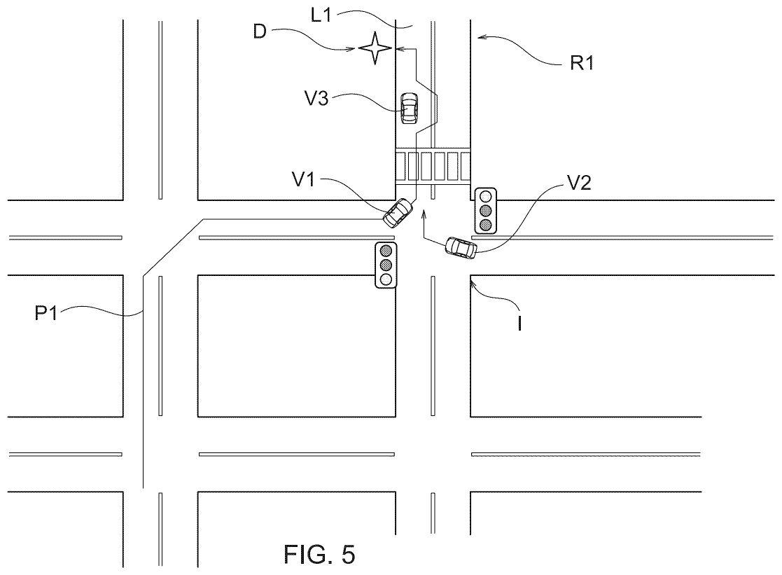

Next, with reference to FIG. 5, a case where there is an obstacle or there is a possibility of an obstacle which interferes the traveling of the subject vehicle in a section between the destination and the target intersection in the connecting traffic lane will be described. FIG. 5 is a drawing illustrating an exemplary situation where there is an obstacle which interferes the traveling of the subject vehicle in a section between the destination and the target intersection in the connecting traffic lane. As illustrated in FIG. 5, when there is an obstacle, such as the parked vehicle V3, in the section between the destination D and the target intersection I in the connecting traffic lane L1, the subject vehicle V1 determines whether the parked vehicle V3 can be overtaken or not after passing through the target intersection I. During the determination, the subject vehicle does not accelerate because the subject vehicle stops or reduces the speed before the parked vehicle V3. Meanwhile, the oncoming vehicle V2 turning right at the target intersection I and entering the connecting traffic lane L1 determines that the subject vehicle V1 would travel in the connecting traffic lane L1 with a speed increase, and therefore, enters the connecting traffic lane with a speed increase corresponding to the determination. Thus, the subject vehicle V1 and the oncoming vehicle V2 are more likely to come close to one another.

The road structure identifying unit 102 identifies the target intersection connected to the connecting traffic lane of the destination side among the connecting traffic lanes at a near side in the traveling direction on the first travel route. For example, the road structure identifying unit 102 obtains information of the nodes and the links on the first travel route from the map information stored in the map DB 2. The road structure identifying unit 102 identifies the connecting traffic lane connected to the destination based on the information of the nodes and the links on the first travel route, and identifies the intersection connected to the connecting traffic lane at a near side in the traveling direction as the target intersection. That is, the road structure identifying unit 102 identifies the intersection through which the subject vehicle needs to pass to enter the connecting traffic lane connected to the destination.

The road structure identifying unit 102 may identify a traffic lane of a destination or via-point side as a connecting traffic lane, and may identify an intersection connected to the traffic lane of the destination or via-point side at a near side in the traveling direction as the target intersection. The connecting traffic lane on the connecting road includes the traffic lane of the destination or via-point side and an oncoming lane opposing the traffic lane of the destination or via-point side. The traffic lane of the destination or via-point side is a traffic lane close to the destination or the via-point among the connecting traffic lanes. When the subject vehicle crosses the traffic lane of the destination or via-point side from the oncoming lane and moves to the destination or the via-point, the subject vehicle may interfere traveling of another vehicle traveling on the traffic lane of the destination or via-point side. Therefore, in the embodiment, the traffic lane of the destination or via-point side is identified as the connecting traffic lane.

In the embodiment, the road structure identifying unit 102 identifies a priority entry lane in which the subject vehicle should travel before entering the target intersection for the subject vehicle to pass through the target intersection on the priority side among the entry lanes entering the target intersection when the target intersection is on the first travel route. The priority entry lane is a traffic lane included in the priority travel route. For example, in the situation illustrated in FIG. 2, the subject vehicle V1 needs to travel in an entry lane L2 among the entry lanes to the target intersection I before entering the target intersection in order to travel through the target intersection I in a straight line and enter the connecting traffic lane L1. Accordingly, the road structure identifying unit 102 identifies the entry lane L2 as a priority entry lane.

After identifying the priority entry lane, the road structure identifying unit 102 identifies an intersection connected to the priority entry lane at a near side in the traveling direction. In the situation illustrated in FIG. 2, the intersection connected to the entry lane L2 as the priority entry lane at a near side in the traveling direction is an intersection I′. Accordingly, the road structure identifying unit 102 identifies the intersection I′ as an intersection connected to the priority entry lane at a near side in the traveling direction.

For the identified intersection, the road structure identifying unit 102 then identifies a priority entry lane corresponding to the intersection. Thus, the road structure identifying unit 102 repeatedly identifies the priority entry lane and the intersection connected to the priority entry lane at a near side in the traveling direction using the target intersection connected to the connecting traffic lane as a starting point. That is, the road structure identifying unit 102 repeatedly executes an intersection identification control that identifies the intersection connected to the identified priority entry lane at a near side in the traveling direction and a traffic lane identification control that identifies the priority entry lane among the entry lanes entering the identified intersection each time the intersection is identified by the intersection identification control. This enables generation of the travel route with which the subject vehicle passes through each intersection, through which the subject vehicle passes, on the priority side.

Thus, in the embodiment, the travel route is generated by alternately identifying the intersections through which the subject vehicle passes and the entry lanes entering the intersections such that the subject vehicle passes through each intersection on the travel route on the priority side. However, when the travel route with which the subject vehicle passes through all the intersections on the travel route from the current location of the subject vehicle to the destination on the priority side is generated, the travel route may take a detour in some cases. Therefore, the road structure identifying unit 102 repeatedly executes the intersection identification control and the traffic lane identification control until the number of executions of the traffic lane identification control reaches the predetermined number of times. Thus limiting the number of executions enables the subject vehicle to travel through the intersections on the travel route on the priority side and enables generation of a travel route that does not take a detour.

The determining unit 103 determines whether the subject vehicle passes through the target intersection on the non-priority side and enters the connecting traffic lane or not. The connecting traffic lane is, for example, a traffic lane of the destination or via-point side connected to the destination. For example, when the subject vehicle turns left at the target intersection on the non-priority side and enters the connecting traffic lane when the subject vehicle travels on the first travel route, or when the subject vehicle turns right at the target intersection on the non-priority side and enters the connecting traffic lane when the subject vehicle travels on the first travel route, the determining unit 103 determines that the subject vehicle passes through the target intersection on the non-priority side and enters the connecting traffic lane.

For example, the determining unit 103 determines whether the traffic light is a traffic light displaying a signal indicating right or left-turn priority or not in addition to the determination of whether the subject vehicle traveling on the first travel route turns right or left at the target intersection and enters the connecting traffic lane or not, and thus, the determining unit 103 may determine whether the subject vehicle passes through the target intersection on the non-priority side and enters the connecting traffic lane or not. The determining unit 103 identifies a type of the traffic light installed at the target intersection based on the map information obtained from the map DB 2, and when the traffic light is not the traffic light displaying the signal indicating right or left-turn priority and the subject vehicle travels on the first travel route, the determining unit 103 determines that the subject vehicle passes through the target intersection on the non-priority side and enters the connecting traffic lane when the subject vehicle turns right or left at the target intersection and enters the connecting traffic lane.

The determining unit 103 determines whether there is a possibility that the subject vehicle fails to smoothly travel when the subject vehicle travels thought the target intersection on the non-priority side or not. For example, the determining unit 103 determines whether the crosswalk of the connecting road side at the target intersection is crowded with pedestrians or not. The determining unit 103 obtains traveling environment information of the crosswalk of the connecting road side at the target intersection. The traveling environment information is, for example, information indicative of the traveling environment of the target intersection obtained by a road sensor installed near the target intersection or a sensor of another vehicle traveling through the target intersection. The traveling environment information may be external event information or may be an estimation result of the degree of congestion at the crosswalk based on the past travel history.

The determining unit 103 calculates the degree of congestion of pedestrians at the crosswalk based on the traveling environment information, and determines that the crosswalk is crowded with pedestrians when the degree of congestion of pedestrians at the crosswalk is equal to or more than a predetermined degree of congestion. The determining unit 103 determines that the crosswalk is not crowded with pedestrians when the degree of congestion of pedestrians at the crosswalk is less than the predetermined degree of congestion. The degree of congestion is, for example, calculated from the number of pedestrians walking on the crosswalk and the size of the crosswalk.

The determining unit 103 determines whether a vehicle speed difference between a vehicle speed of the subject vehicle and a vehicle speed of the oncoming vehicle turning right at the target intersection and entering the connecting traffic lane increases or not when the subject vehicle turns left at the target intersection and enters the connecting traffic lane. The case where the vehicle speed difference between the vehicle speed of the subject vehicle and the vehicle speed of the oncoming vehicle increases is, for example, a situation where there is a possibility that the oncoming vehicle turns right at the target intersection and enters the connecting traffic lane while accelerating. In the embodiment, the determining unit 103 obtains road information of the target intersection, and determines that the vehicle speed difference increases when there is installed no traffic light which displays that the oncoming vehicle is allowed to preferentially turn right at the target intersection and enter the connecting traffic lane in the oncoming lane where the oncoming vehicle travels based on the road information of the target intersection.

The determining unit 103 determines that the vehicle speed difference between the vehicle speed of the subject vehicle and the vehicle speed of the oncoming vehicle increases when the traffic light installed in the oncoming lane has a short period of time in displaying that the oncoming vehicle is allowed to preferentially turn right at the target intersection and enter the connecting traffic lane. For example, the determining unit 103 obtains information of traffic lights including a display time of each signal of the traffic lights at the target intersection from the map DB 2, and determines that the vehicle speed difference between the vehicle speed of the subject vehicle and the vehicle speed of the oncoming vehicle increases when the display time displaying that the oncoming vehicle is allowed to preferentially pass through is shorter than a predetermined period of time. When the oncoming vehicle turns right at the target intersection on the non-priority side and enters the connecting traffic lane, the right turn at the target intersection needs to be completed in a short period of time until the signal is switched to a signal indicating a prohibition of passing after prioritizing the traveling of the vehicle turning left at the target intersection, and the oncoming vehicle is more likely to accelerate. Accordingly, when there is no traffic light displaying that the oncoming vehicle is allowed to preferentially pass through or when the display time is short, the oncoming vehicle is more likely to accelerate and pass through the target intersection, and as a result, the vehicle speed difference between the vehicle speed of the subject vehicle and the vehicle speed of the oncoming vehicle increases.

The determining unit 103 may determine that the vehicle speed difference between the vehicle speed of the subject vehicle and the vehicle speed of the oncoming vehicle increases when the target intersection is an intersection having a road structure without a traffic lane exclusive for right turn and with which a vehicle waiting to turn right interferes traveling of the vehicle behind, or when the target intersection is an intersection having a road structure with which a traffic jam is caused by a vehicle waiting to turn right. Also in the case as described above, the driver of the oncoming vehicle tends to consider that it is necessary to promptly turn right at the target intersection and accelerate the oncoming vehicle.

The determining unit 103 determines whether the destination is located within a predetermined distance from the target intersection or not based on the location of the destination and the location of the target intersection. The determining unit 103 calculates the distance of the section between the location of the destination and the location of the target intersection, and determines that the destination is located within the predetermined distance from the target intersection when the calculated distance is within the predetermined distance. The determining unit 103 determines that the destination is not located within the predetermined distance from the target intersection when the calculated distance is longer than the predetermined distance.

The determining unit 103 determines whether there is an obstacle or there is a possibility of an obstacle which interferes the traveling of the subject vehicle in a section between the destination and the target intersection in the connecting traffic lane or not. The obstacle includes, for example, a parked vehicle and a construction site. The determining unit 103 obtains traveling environment information in the section between the destination and the target intersection in the connecting traffic lane. The traveling environment information is information indicative of a traveling environment of the target intersection obtained by a road sensor installed near the target intersection or a sensor of another vehicle traveling through the target intersection. The traveling environment information may be construction information stored in the map DB 2. The determining unit 103 determines whether there is an obstacle in the section between the destination and the target intersection in the connecting traffic lane or not based on the traveling environment information.

The determining unit 103 estimates presence/absence of an obstacle based on the past travel history, and determines whether there is a possibility of an obstacle in the section between the destination and the target intersection in the connecting traffic lane or not based on the estimation result of the presence/absence of the obstacle.

The determining unit 103 determines whether the subject vehicle enters a traffic lane other than the traffic lane closest to the subject vehicle after passing through the target intersection or not when the connecting road is a road with two or more traffic lanes on one side. For example, the determining unit 103 determines that the subject vehicle enters a traffic lane other than the traffic lane closest to the subject vehicle after passing through the target intersection when there is an obstacle on the traffic lane closest to the subject vehicle. The obstacle includes a parked vehicle and a construction site. The determining unit 103 determines, for example, that the subject vehicle enters a traffic lane other than the traffic lane closest to the subject vehicle simultaneously with right or left turn when the subject vehicle needs to turn right or left after traveling on the connecting road. For example, the determining unit 103 determines that the subject vehicle enters a traffic lane other than the traffic lane closest to the subject vehicle when an entrance to a highway is on a side of the traffic lane other than the traffic lane closest to the subject vehicle.

Note that, while in the embodiment, the controller 7 outputs the information of the travel route to the vehicle control device 5 when the travel route is generated, the embodiment is not limited to this, and the controller 7 may have a function of controlling the traveling of the vehicle. For example, the controller 7 calculates a target vehicle speed and a target steering angle such that the subject vehicle travels along the travel route. The controller 7 generates respective control signals including the calculated target vehicle speed and target steering angle, and outputs them to the vehicle speed control device 51 and the steering control device 52.

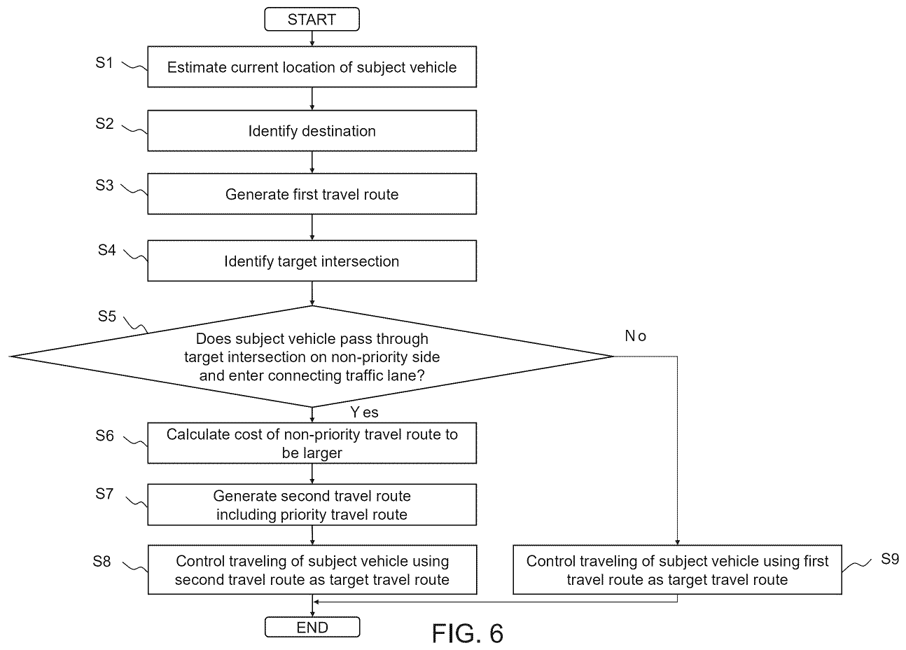

Next, with reference to a flowchart in FIG. 6, a procedure of the travel route generation method according to the embodiment will be described. FIG. 6 is a flowchart diagram illustrating an exemplary control procedure of the travel route generation method according to the embodiment. In the embodiment, as soon as the driver of the subject vehicle inputs the destination, the controller 7 starts a control process from Step S1.

At Step S1, the controller 7 estimates the current location of the subject vehicle on the map. At Step S2, the controller 7 identifies the destination of the subject vehicle on the map. At Step S3, the controller 7 generates the first travel route from the current location of the subject vehicle to the destination. For example, the controller 7 generates a travel route with the smallest cost among the plurality of travel routes from the current location of the subject vehicle to the destination as the first travel route. At Step S4, the controller 7 identifies the intersection connected to the connecting traffic lane included in the connecting road connected to the destination at a near side in the traveling direction on the first travel route as the target intersection.

At Step S5, the controller 7 determines whether the subject vehicle passes through the target intersection on the non-priority side and enters the connecting traffic lane or not. When determining that the subject vehicle passes through the target intersection on the non-priority side and enters the connecting traffic lane, the controller 7 proceeds with the process to Step S6. When determining that the subject vehicle does not pass through the target intersection on the non-priority side and does not enter the connecting traffic lane, the controller 7 proceeds with the process to Step S9.

At Step S6, the controller 7 calculates the cost of the non-priority travel route to be larger than the cost of the priority travel route. The controller 7 obtains the non-priority travel route and the priority travel route as the travel route with which the subject vehicle passes through the target intersection identified at Step S4 and enters the connecting traffic lane, and calculates the cost of the non-priority travel route to be larger than the cost of the priority travel route. At Step S7, the controller 7 generates the second travel route including the priority travel route with a smaller cost as the target travel route. At Step S8, the controller 7 controls the traveling of the subject vehicle using the second travel route as the target travel route. At Step S9, the controller 7 controls the traveling of the subject vehicle using the first travel route as the target travel route.

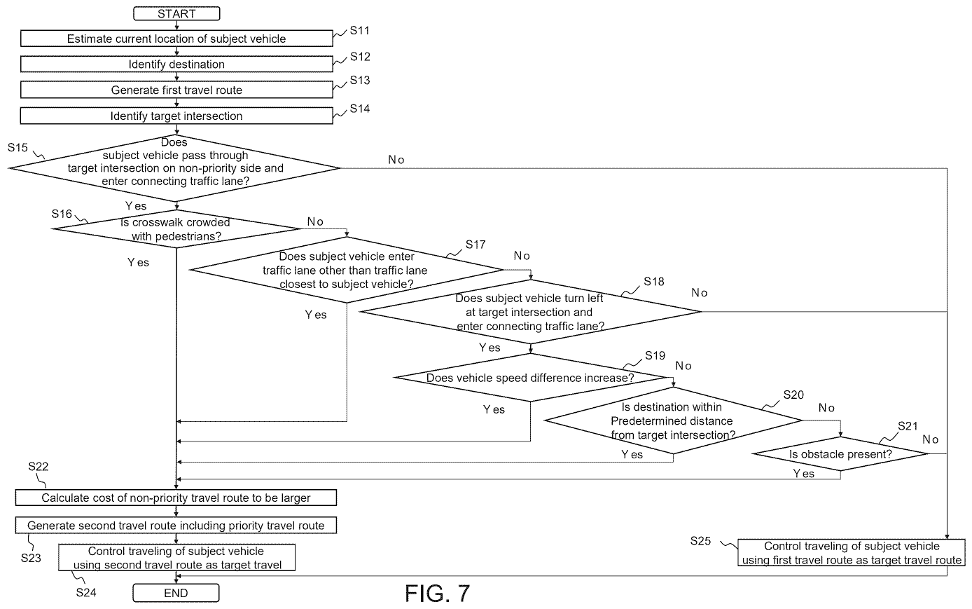

Next, with reference to a flowchart in FIG. 7, a procedure of generating a travel route according to the embodiment will be described. FIG. 7 is a flowchart diagram illustrating an exemplary control procedure of the travel route generation method according to the embodiment. Since Steps S11 to 15, and S22 to 25 in FIG. 7 are similar to Steps S1 to 5, and Steps S6 to 9 in FIG. 6, their explanations are omitted. As illustrated in FIG. 7, the controller 7 proceeds with the process to Step S16 when determining that the subject vehicle passes through the target intersection on the non-priority side and enters the connecting traffic lane at Step S15. When determining that the subject vehicle does not pass through the target intersection on the non-priority side and does not enter the connecting traffic lane at Step S15, the controller 7 proceeds with the process to Step S25.

At Step S16, the controller 7 determines whether the crosswalk at the target intersection is crowded with pedestrians or not. The controller 7 proceeds with the process to Step S22 when determining that the crosswalk at the target intersection is crowded with pedestrians. The controller 7 proceeds with the process to Step S17 when determining that the crosswalk at the target intersection is not crowded with pedestrians. At Step S17, the controller 7 determines whether the subject vehicle enters the traffic lane other than the traffic lane closest to the subject vehicle after passing through the target intersection or not. When determining that the subject vehicle enters the traffic lane other than the traffic lane closest to the subject vehicle after passing through the target intersection, the controller 7 proceeds with the process to Step S22. When determining that the subject vehicle does not enter the traffic lane other than the traffic lane closest to the subject vehicle after passing through the target intersection, the controller 7 proceeds with the process to Step S18.

At Step S18, the controller 7 determines whether the subject vehicle turns left at the target intersection on the first travel route and enters the connecting traffic lane or not based on the first travel route. When determining that the subject vehicle turns left at the target intersection and enters the connecting traffic lane, the controller 7 proceeds with the process to Step S19. When determining that the subject vehicle does not turn left at the target intersection and does not enter the connecting traffic lane, the controller 7 proceeds with the process to Step S25. At Step S19, the controller 7 determines whether the vehicle speed difference between the vehicle speed of the subject vehicle and the vehicle speed of the oncoming vehicle increases or not. When determining that the vehicle speed difference between the vehicle speed of the subject vehicle and the vehicle speed of the oncoming vehicle increases, the controller 7 proceeds with the process to Step S22. When determining that the vehicle speed difference between the vehicle speed of the subject vehicle and the vehicle speed of the oncoming vehicle does not increase, the controller 7 proceeds with the process to Step S20.

At Step S20, the controller 7 determines whether the destination is within the predetermined distance from the target intersection or not. When determining that the destination is within the predetermined distance from the target intersection, the controller 7 proceeds with the process to Step S22. When determining that the destination is not within the predetermined distance from the target intersection, the controller 7 proceeds with the process to Step S21. At Step S21, the controller 7 determines whether an obstacle is present in the connecting traffic lane of the destination side or not. When determining that there is an obstacle in the connecting traffic lane of the destination side, the controller 7 proceeds with the process to Step S22. When determining that there is no obstacle in the connecting traffic lane of the destination side, the controller 7 proceeds with the process to Step S25. Note that, while in the embodiment, all the determinations of Steps S16 to 21 are executed, the embodiment is not limited to this, and at least any one of the determinations of Steps S16 to 21 may be executed.

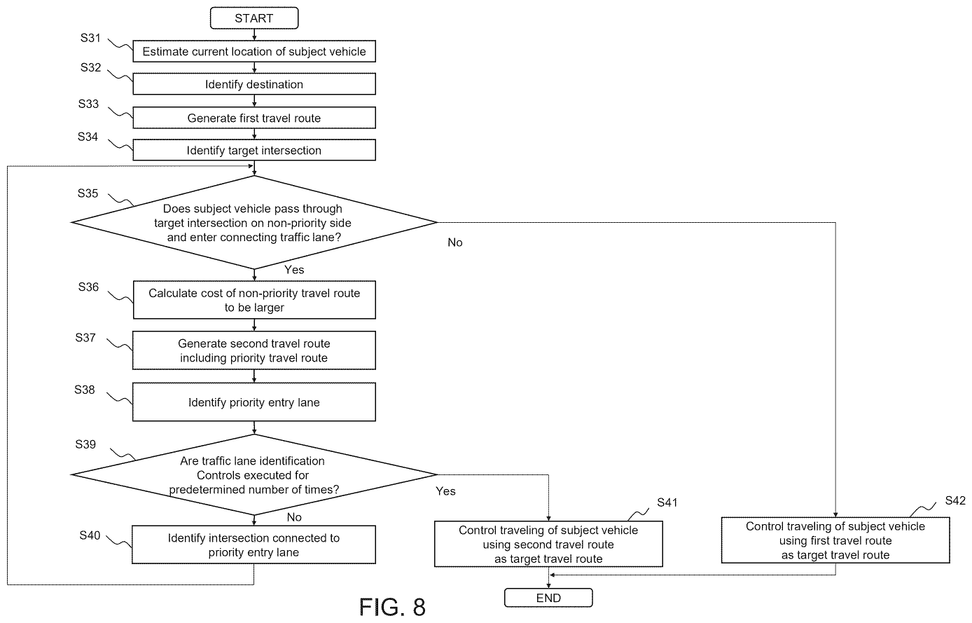

Next, with reference to a flowchart in FIG. 8, a procedure of the travel route generation method according to the embodiment will be described. FIG. 8 is a flowchart diagram illustrating an exemplary control procedure of the travel route generation method according to the embodiment. Steps S31 to 35 in FIG. 8 are similar to Steps S1 to 5 in FIG. 6, and therefore, their explanations are omitted. As illustrated in FIG. 8, the controller 7 proceeds with the process to Step S36 when determining that the subject vehicle passes through the target intersection on the non-priority side and enters the connecting traffic lane at Step S35. When determining that the subject vehicle does not pass through the target intersection on the non-priority side and does not enter the connecting traffic lane at Step S35, the controller 7 proceeds with the process to Step S42.

At Step S36, the controller 7 calculates the cost of the non-priority travel route to be larger than the cost of the priority travel route. At Step S37, the controller 7 generates the second travel route including the priority travel route with a smaller cost as the target travel route. At Step S38, the controller 7 executes the traffic lane identification control identifying the priority entry lane in which the subject vehicle should travel before entering the target intersection in order for the subject vehicle to pass through the target intersection on the priority side among the entry lanes for entering the identified target intersection. At Step S39, the controller 7 determines whether the traffic lane identification controls are executed for the predetermined number of times or not. When determining that the traffic lane identification controls are not executed for the predetermined number of times, the controller 7 proceeds with the process to Step S40. When determining that the traffic lane identification controls are executed for the predetermined number of times, the controller 7 proceeds with the process to Step S41.

At Step S40, the controller 7 identifies the intersection connected to the priority entry lane identified at Step S38 at a near side in the traveling direction. The controller 7 returns the process to Step S35 after identifying the intersection, and repeats the following process for the intersection identified at Step S40. That is, at Step S35, the controller 7 determines whether the subject vehicle passes through the target intersection on the non-priority side and enters the connecting traffic lane or not. At Step S41, the controller 7 controls the traveling of the subject vehicle using the second travel route including the priority entry lane identified by the traffic lane identification controls executed for the predetermined number of times as the target travel route. At Step S42 the controller 7 controls the traveling of the subject vehicle using the first travel route as the target travel route.

As described above, in the embodiment, a controller determines whether the subject vehicle passes through a target intersection on a non-priority side prioritizing move of another moving body over traveling of the subject vehicle and enters a connecting traffic lane included in a connecting road connected to the destination or the via-point or not, and generates the target travel route with which the subject vehicle passes through the target intersection on a priority side allowing the subject vehicle to preferentially travel over the move of the other moving body and enters the connecting traffic lane when the subject vehicle passes through the target intersection on the non-priority side and enters the connecting traffic lane. The target intersection is an intersection connected to the destination or the via-point via the connecting traffic lane and located at a near side in a traveling direction in the connecting traffic lane. This enables the subject vehicle to smoothly travel through the intersection through which the subject vehicle needs to pass in order to enter the road connected to the destination or the via-point of the subject vehicle.

In the embodiment, the controller generates a first travel route from a current location of the subject vehicle to the destination and/or the via-point as the target travel route; determines whether the subject vehicle passes through the target intersection on the non-priority side and enters the connecting traffic lane on the first travel route or not; and changes the target travel route from the first travel route to a second travel route with which the subject vehicle passes through the target intersection on the priority side and enters the connecting traffic lane when the subject vehicle passes through the target intersection on the non-priority side and enters the connecting traffic lane on the first travel route. This enables an update of the travel route to the travel route on which the subject vehicle can smoothly travel through the intersection when the subject vehicle passes through the target intersection on the non-priority side and enters the connecting traffic lane on the generated travel route.

In the embodiment, the controller identifies an intersection connected to a traffic lane of a side of the destination or the via-point among the connecting traffic lanes at a near side in the traveling direction as the target intersection; and determines whether the subject vehicle passes through the target intersection on the non-priority side and enters the traffic lane of the destination or the via-point side or not. This enables preventing the travel route with which the subject vehicle crosses the oncoming lane on the connecting road and enters the destination or the via-point from being generated, and limiting the intersection through which the subject vehicle travels.

In the embodiment, the controller obtains a non-priority travel route with which the subject vehicle passes through the target intersection on the non-priority side and enters the connecting traffic lane, and a priority travel route with which the subject vehicle passes through the target intersection on the priority side and enters the connecting traffic lane; calculates a cost of the non-priority travel route to be larger than a cost of the priority travel route; and generates the target travel route including the priority travel route with a smaller cost. This enables generation of the travel route with which the subject vehicle can pass through the intersection on the priority side, and enables the subject vehicle to smoothly travel through the intersection.

In the embodiment, the controller, as the priority travel route, obtains a priority left-turn route with which the subject vehicle turns left at the target intersection on the priority side and enters the connecting traffic lane, a priority straight route with which the subject vehicle travels through the target intersection in a straight line on the priority side and enters the connecting traffic lane, and a priority right-turn route with which the subject vehicle turns right at the target intersection on the priority side and enters the connecting traffic lane; calculates a cost of the priority right-turn route to be larger than a cost of the priority left-turn route and a cost of the priority straight route; and generates the target travel route including the priority left-turn route or the priority straight route with a smaller cost. This enables the subject vehicle to travel through the intersection along the travel route with which the subject vehicle travels through the intersection in a straight line or the travel route with which the subject vehicle turns left at the intersection among the travel routes with which the subject vehicle passes through the intersection on the priority side.

In the embodiment, the controller identifies a priority entry lane in which the subject vehicle should travel before entering the target intersection in order for the subject vehicle to pass through the target intersection on the priority side among entry lanes entering the target intersection when the subject vehicle passes through the target intersection on the non-priority side and enters the connecting traffic lane; repeatedly executes an intersection identification control identifying an intersection connected to the identified priority entry lane at the near side in the traveling direction and a traffic lane identification control identifying the priority entry lane among the entry lanes entering the identified intersection each time the intersection is identified by the intersection identification control until an execution count of the traffic lane identification control reaches a predetermined count of times; after executing the traffic lane identification control for the predetermined count of times, generates the target travel route with which the subject vehicle travels in the priority entry lane identified by the traffic lane identification control. This enables generation of the travel route with which the subject vehicle can pass, on the priority side, through each intersection by repeating the identification of the intersection through which the subject vehicle needs to pass and the identification of the entry lane in which the subject vehicle should travel before entering the intersection among the entry lanes entering the intersection. For example, even when the subject vehicle needs to turn right or left at any of the intersections on the travel route from the current location of the subject vehicle to the destination or the via-point, the intersection at which the subject vehicle can turn right or left on the priority side can be identified.

In the embodiment, the controller obtains traveling environment information of a crosswalk of a side of the connecting road at the target intersection; determines whether the crosswalk is crowded with pedestrians or not based on the traveling environment information; and generates the target travel route with which the subject vehicle passes through the target intersection on the priority side and enters the connecting traffic lane when the crosswalk is crowded with the pedestrians. This enables generation of the travel route with which the subject vehicle can travel through the intersection with the crosswalk crowded with pedestrians on the priority side.

In the embodiment, the controller determines whether a vehicle speed difference between a vehicle speed of the subject vehicle and a vehicle speed of an oncoming vehicle turning right at the target intersection and enters the connecting traffic lane increases or not when the subject vehicle turns left at the target intersection on the non-priority side and enters the connecting traffic lane; and generates the target travel route with which the subject vehicle passes through the target intersection on the priority side and enters the connecting traffic lane when determining that the vehicle speed difference increases. This enables preventing the oncoming vehicle turning right at the intersection from coming close to the subject vehicle and suddenly decelerating when the subject vehicle is turning left at the intersection.

In the embodiment, the controller determines that the vehicle speed difference increases when a traffic light which displays that the oncoming vehicle is allowed to preferentially turn right at the target intersection and enter the connecting traffic lane is not installed in an oncoming lane in which the oncoming vehicle travels at the target intersection, or when a time period of displaying that the oncoming vehicle is allowed to preferentially turn right at the target intersection and enter the connecting traffic lane is short on a traffic light installed in the oncoming lane. This enables prediction that the vehicle speed difference between the subject vehicle and the oncoming vehicle increases in the case of the situation where the oncoming vehicle is more likely to increase the speed and turn right at the intersection.

In the embodiment, the controller determines whether the destination or the via-point is located within a predetermined distance from the target intersection or not based on a location of the destination or the via-point and a location of the target intersection; and generates the target travel route with which the subject vehicle passes through the target intersection on the priority side and enters the connecting traffic lane when determining that the destination or the via-point is located within the predetermined distance from the target intersection. This enables preventing the oncoming vehicle turning right at the intersection from coming close to the subject vehicle and suddenly decelerating when the subject vehicle does not accelerate after passing through the intersection.

In the embodiment, the controller obtains traveling environment information of a section between the destination or the via-point and the target intersection in the connecting traffic lane; determines whether there is an obstacle which interferes traveling of the subject vehicle or there is a possibility of the obstacle in the section or not based on the traveling environment information; and when determining that there is the obstacle or there is the possibility of the obstacle, generates the target travel route with which the subject vehicle passes through the target intersection on the priority side and enters the connecting traffic lane. This enables preventing the oncoming vehicle turning right at the intersection from coming close to the subject vehicle and suddenly decelerating when the subject vehicle does not accelerate after passing through the intersection due to the determination of overtaking the obstacle.

In the embodiment, the controller determines whether the subject vehicle enters a traffic lane other than a traffic lane closest to the subject vehicle after passing through the target intersection or not when the connecting road is a road having two or more traffic lanes on one side; and generates the target travel route with which the subject vehicle passes through the target intersection on the priority side and enters the connecting traffic lane when determining that the subject vehicle enters the traffic lane other than the traffic lane closest to the subject vehicle after passing through the target intersection. This enables preventing the oncoming vehicle turning right at the intersection from coming close to the subject vehicle and suddenly decelerating in the traffic lane when the subject vehicle enters the traffic lane other than the traffic lane closest to the subject vehicle after passing through the intersection.

The embodiment described above has been described for ease of understanding of the present invention, and has not been described for limiting the present invention. Accordingly, each component disclosed in the above-described embodiment has a gist including even all the design changes and equivalents belonging to the technical scope of the present invention.

1. A travel route generation method, executed by a controller, for generating a target travel route of a subject vehicle to at least one of a destination and a via-point, wherein
the controller:
determines whether the subject vehicle is on a priority side allowing the subject vehicle to preferentially travel over move of a pedestrian crossing a crosswalk or on a non-priority side prioritizing the move of the pedestrian over traveling of the subject vehicle in a situation where the subject vehicle passes through a target intersection and enters a connecting traffic lane included in a connecting road connected to the destination or the via-point; and
generates the target travel route with which the subject vehicle passes through the target intersection on the priority side and enters the connecting traffic lane when the subject vehicle is on the non-priority side, and
the target intersection is an intersection connected to the destination or the via-point via the connecting traffic lane and located at a near side in a traveling direction in the connecting traffic lane.

2. The travel route generation method according to claim 1, wherein
the controller:
generates a first travel route from a current location of the subject vehicle to the at least one of the destination and the via-point as the target travel route;
determines whether the subject vehicle is on the priority side or on the non-priority side in a situation where the subject vehicle passes through the target intersection and enters the connecting traffic lane on the first travel route; and
changes the target travel route from the first travel route to a second travel route with which the subject vehicle passes through the target intersection on the priority side and enters the connecting traffic lane when the subject vehicle is on the non-priority side.

3. The travel route generation method according to claim 1, wherein
the controller:
identifies an intersection connected to a traffic lane of a side of the destination or the via-point among the connecting traffic lanes at a near side in the traveling direction as the target intersection; and
determines whether the subject vehicle is on the priority side or on the non-priority side in a situation where the subject vehicle passes through the target intersection and enters the traffic lane of the destination or the via-point side.

4. The travel route generation method according to claim 1, wherein
the controller:
obtains a non-priority travel route with which the subject vehicle passes through the target intersection on the non-priority side and enters the connecting traffic lane, and a priority travel route with which the subject vehicle passes through the target intersection on the priority side and enters the connecting traffic lane;
calculates a cost of the non-priority travel route to be larger than a cost of the priority travel route; and
generates the target travel route including the priority travel route with a smaller cost.

5. The travel route generation method according to claim 4, wherein
the controller:
as the priority travel route, obtains a priority left-turn route with which the subject vehicle turns left at the target intersection on the priority side and enters the connecting traffic lane, a priority straight route with which the subject vehicle travels through the target intersection in a straight line on the priority side and enters the connecting traffic lane, and a priority right-turn route with which the subject vehicle turns right at the target intersection on the priority side and enters the connecting traffic lane;
calculates a cost of the priority right-turn route to be larger than a cost of the priority left-turn route and a cost of the priority straight route; and
generates the target travel route including the priority left-turn route or the priority straight route with a smaller cost.

6. The travel route generation method according to claim 1, wherein
the controller:
identifies a priority entry lane in which the subject vehicle should travel before entering the target intersection in order for the subject vehicle to pass through the target intersection on the priority side among entry lanes entering the target intersection when the subject vehicle passes through the target intersection on the non-priority side and enters the connecting traffic lane;
repeatedly executes an intersection identification control identifying an intersection connected to the identified priority entry lane at the near side in the traveling direction and a traffic lane identification control identifying the priority entry lane among the entry lanes entering the identified intersection each time the intersection is identified by the intersection identification control until an execution count of the traffic lane identification control reaches a predetermined count of times;
after executing the traffic lane identification control for the predetermined count of times, generates the target travel route with which the subject vehicle travels in the priority entry lane identified by the traffic lane identification control.

7. The travel route generation method according to claim 1, wherein
the controller:
obtains traveling environment information of a crosswalk of a side of the connecting road at the target intersection;
determines whether the crosswalk is crowded with pedestrians or not based on the traveling environment information; and
generates the target travel route with which the subject vehicle passes through the target intersection on the priority side and enters the connecting traffic lane when the crosswalk is crowded with the pedestrians.

8. The travel route generation method according to claim 1, wherein
the controller:
determines whether a vehicle speed difference between a vehicle speed of the subject vehicle and a vehicle speed of an oncoming vehicle turning right at the target intersection and enters the connecting traffic lane increases or not when the subject vehicle turns left at the target intersection on the non-priority side and enters the connecting traffic lane; and
generates the target travel route with which the subject vehicle passes through the target intersection on the priority side and enters the connecting traffic lane when determining that the vehicle speed difference increases.

9. The travel route generation method according to claim 8, wherein
the controller determines that the vehicle speed difference increases when a traffic light which displays that the oncoming vehicle is allowed to preferentially turn right at the target intersection and enter the connecting traffic lane is not installed in an oncoming lane in which the oncoming vehicle travels at the target intersection, or when a time period of displaying that the oncoming vehicle is allowed to preferentially turn right at the target intersection and enter the connecting traffic lane is short on a traffic light installed in the oncoming lane.

10. The travel route generation method according to claim 1, wherein
the controller:
determines whether the destination or the via-point is located within a predetermined distance from the target intersection or not based on a location of the destination or the via-point and a location of the target intersection; and
generates the target travel route with which the subject vehicle passes through the target intersection on the priority side and enters the connecting traffic lane when determining that the destination or the via-point is located within the predetermined distance from the target intersection.

11. The travel route generation method according to claim 1, wherein
the controller:
obtains traveling environment information of a section between the destination or the via-point and the target intersection in the connecting traffic lane;
determines whether there is an obstacle which interferes traveling of the subject vehicle or there is a possibility of the obstacle in the section or not based on the traveling environment information; and
when determining that there is the obstacle or there is the possibility of the obstacle, generates the target travel route with which the subject vehicle passes through the target intersection on the priority side and enters the connecting traffic lane.

12. The travel route generation method according to claim 1, wherein
the controller:
determines whether the subject vehicle enters a traffic lane other than a traffic lane closest to the subject vehicle after passing through the target intersection or not when the connecting road is a road having two or more traffic lanes on one side; and
generates the target travel route with which the subject vehicle passes through the target intersection on the priority side and enters the connecting traffic lane when determining that the subject vehicle enters the traffic lane other than the traffic lane closest to the subject vehicle after passing through the target intersection.

13. A travel route generation device comprising:
a controller configured to generate a target travel route of a subject vehicle to at least one of a destination and a via-point, wherein
the controller:
determines whether the subject vehicle is on a priority side allowing the subject vehicle to preferentially travel over move of a pedestrian crossing a crosswalk or on a non-priority side prioritizing the move of the pedestrian over traveling of the subject vehicle in a situation where the subject vehicle passes through a target intersection, and enters a connecting traffic lane included in a connecting road connected to the destination or the via-point; and
generates the target travel route with which the subject vehicle passes through the target intersection on the priority side and enters the connecting traffic lane when the subject vehicle is on the non-priority side, and
the target intersection is an intersection connected to the destination or the via-point via the connecting traffic lane and located at a near side in a traveling direction in the connecting traffic lane.
